(19) United States
(12) Patent Application Publication
(10) Pub. No.: US 2006/0185206 A1
(43) Pub. Date: Aug. 24, 2006

(54) Decorative display assembly and method for displaying signs

(76) Inventor: Tammy Lisa Du Bose, Pasadena, TX (US)

Correspondence Address: Anastassios Triantaphyllis, P.O. Box 27629, Houston, TX, 77227, US

(21) Appl. No.: 11/346,644

(22) Filed: Feb. 3, 2006

Related U.S. Application Data
(60) Provisional application No. 60/649,499, filed on Feb. 3, 2005.

(51) Int. Cl. G09F 15/00

(52) U.S. Cl. 40/610

(57) ABSTRACT

A decorative display frame is formed by assembling and connecting pipe sections and fittings. In the assembled position, an upper frame member is connected to two side frame members via two elbows, a lower frame member is connected to the two side frame members via two tee connectors, a first support is connected to the first side frame member and the lower frame member via the first tee connector and a second support is connected to the second side frame member and the lower frame member via the second tee connector. The decorative display frame is supported in an upright position by the two supports which are inserted securely in the ground of a yard or other outdoor surface. A picture, an announcement or other sign is attached to the decorative display frame for display.

### RELATED PRIORITY DATE APPLICATION

This application claims the benefit under 35 U.S.C. 119(e) of the U. S. provisional application number 60/649,499 filed on Feb. 3, 2005.

### TECHNICAL FIELD OF THE INVENTION

The present invention relates to decorative displays and, more particularly, to decorative display assemblies for displaying signs, pictures, poster or other information bearing media. Still more particularly, the present invention discloses a decorative display frame formed by connecting tubes and connectors thereof.

### BACKGROUND OF THE INVENTION

Various outdoors displays including yard decorations are a popular way to celebrate holidays, birthdays, graduations, anniversaries, births and other celebrations or special occasions. An example of such decorations are wooden cutouts such as garden signs or bird houses. Even though many such displays are pleasant to the eye and bring excitement to an occasion, they not personalized and are cumbersome.

Other displays are portable billboards for announcing special occasions. Such a sign typically includes an upright easel with a supporting structure for removable letters. Such signs are frequently illuminated. Removable letters are inserted to spell out the desired message. One disadvantage of those signs is that they are large (several feet high), ostentatious, and comparatively expensive to rent.

Other signs for announcing special occasions are also commercially available. These fall generally into two categories, namely, those in which the sign as sold to the user is affixed to a stake (e.g., by glue or staples), and those in which the sign is supplied without mounting materials (e.g., a stake and some means for securing the sign to the stake). These signs are not personal either and generally are not reusable.

The disadvantages of the prior art cases are overcome by providing a decorative display frame formed by tubular pieces and connectors thereof which can be easily connected, either permanently or temporarily. The assemblies are inexpensive and reusable and easily transported and stored. They displays effected with these frames are personalized and pleasing to the eyes.

These and other advantages of the present invention will become apparent from the following description and drawings.

### SUMMARY OF THE INVENTION

According to the present invention, a decorative display frame is formed by assembling and connecting inexpensive tubular members and fittings commonly used in plumbing applications or the like. The decorative display frame includes an upper frame member, a lower frame member, two ninety (90) degree elbows, two side frame members, two tee connectors and two supports. The upper frame member, the lower frame member, the two side frame members, and the two supports are elongated straight cylindrical pipe sections obtained by cutting pipe sections out of a PVC pipe to suitable lengths. The two elbows and two connectors are fittings typically used to couple cylindrical pipe sections.

In the assembled position, the upper frame member is connected to the side frame members via the two elbows, the lower frame member is connected to the side frame members via the two tee connectors, the first support is connected to the first side frame member and the lower frame member via the first tee connector and the second support is connected to the second side frame member and the lower frame member via the second tee connector.

The decorative display frame is supported in an upright position by the two supports which are inserted securely in the ground of a yard or other outdoor surface. A picture, an announcement or other sign is attached to the decorative display frame for display.

### BRIEF DESCRIPTION OF THE DRAWINGS

For a detailed description of the preferred embodiment of the invention, reference will now be made to the accompanying drawings wherein:

FIG. 1 is an exploded, perspective view of an unassembled decorative display frame made in accordance with the present invention; and

FIG. 2 is an assembled decorative display frame made in accordance with the present invention.

### DESCRIPTION OF THE PREFERRED EMBODIMENTS

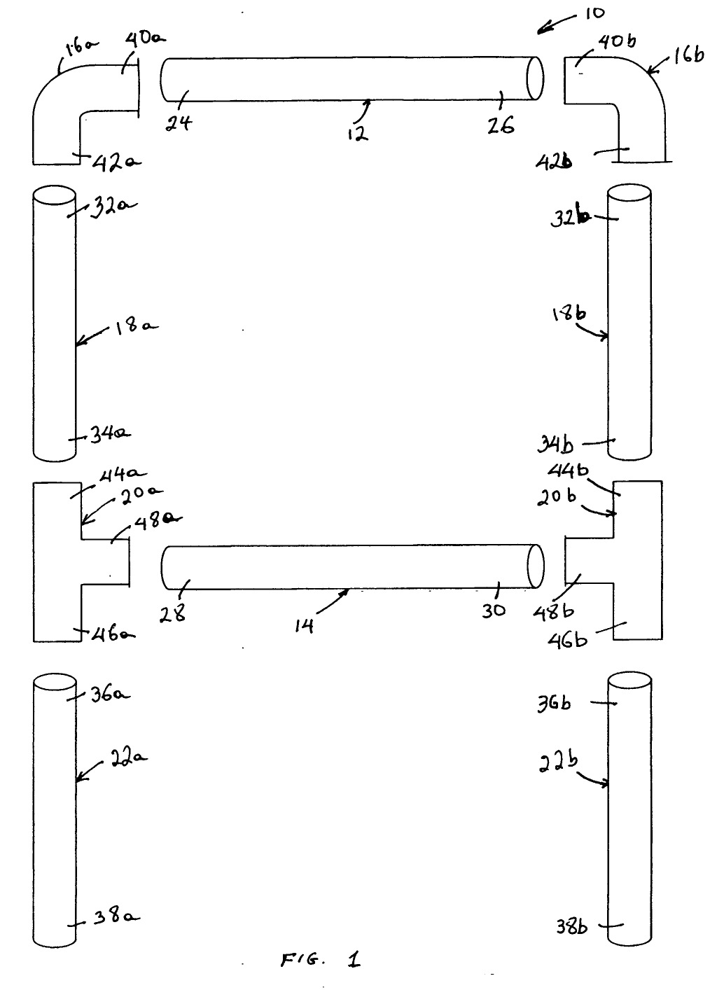

According to the present invention, a decorative display frame is disclosed formed by assembling and connecting inexpensive tubular members commonly used in plumbing applications or the like. Referring initially to FIG. 1, there is shown in disassembled relationship the parts comprising a decorative display frame of the present invention, generally designated by the numeral 10. In the following description, like parts are marked throughout the specification and drawings with the same reference numerals. The drawing figures are not necessarily to scale and certain features of the invention may be shown in exaggerated scale in the interest of clarity.

Decorative display frame 10 includes an upper frame member 12, a lower frame member 14, ninety (90) degree elbows 16a and 16b, side frame members 18a and 18b, tee connectors 20a and 20b and supports 22a and 22b. Upper frame member 12, lower frame member 14, side frame members 18a and 18b, and supports 22a and 22b are elongated straight cylindrical pipe sections, preferably of plastic material and, most preferably, PVC material. They are obtained by cutting pipe sections out of a PVC pipe to suitable lengths, depending on the desired dimensions of the frame. Accordingly, they have the same inner and outer diameter and cylindrical wall thickness. The lengths of upper frame member 12, side frame member 18a and support 22a are substantially equal to the lengths of lower frame member 14, side frame member 18b, and support 22b, respectively.

Upper frame member 12 has upper frame member ends 24 and 26, lower frame member 14 has lower frame member ends 28 and 30, side frame members 18a has side frame member ends 32a and 34a, side frame member 18b has side frame member ends 32b and 34b, support 22a has support ends 36a and 38a and support 22b has support ends 36b and 38b.

Ninety (90) degree elbows 16a and 16b are angular pipe fittings typically used to couple cylindrical pipe sections. Elbow 16a has elbow sections 40a and 42a and elbow 16b has elbow sections 40b and 42b.

Tee connectors 20a and 20b are connectors typically used to connect three pipe sections in a “T” configuration. Tee connector 20a has longitudinally aligned ends 44a and 46a and end 48a. Similarly, tee connector 20b has longitudinally aligned ends 44b and 46b and end 48b.

Elbows 16a and 16b and tee connectors 20a and 20b are constructed of the same material as the other pipe components described above and have an inner diameter suitable for intimately receiving those pipe components to effect a secure connection therebetween.

Still referring to FIG. 1, decorative display frame 10 is assembled by connecting upper frame member 12 to side frame members 18a and 18b via elbows 16a and 16b, respectively, lower frame member 14 to side frame members 18a and 18b via tee connectors 20a and 20b, respectively, support 22a to side frame member 18a and lower frame member 14 via tee connector 20a and support 22b to side frame member 18b and lower frame member 14 via tee connector 20b.

More particularly, ends 24 and 26 of upper frame member 12 are intimately received in end 40a of elbow 16a and end 40b of elbow 16b, respectively. Ends 32a and 34a of side frame member 18a are intimately received in end 42a of elbow 16a and end 44a of tee connector 20a, respectively. Ends 32b and 34b of side frame member 18b are intimately received in end 42b of elbow 16b and end 44b of tee connector 20b, respectively. Ends 28 and 30 of lower frame member 14 are intimately received in end 48a of tee connector 20a and end 48b of tee connector 20b. End 36a of support 22a is intimately received in end 46a of tee connector 20a. End 36b of support 22b is intimately received in end 46b of tee connector 20b. The connections between the pipe portions and the elbows and tee connectors described above are preferably strengthened by placing suitable adhesive material on the contact surfaces.

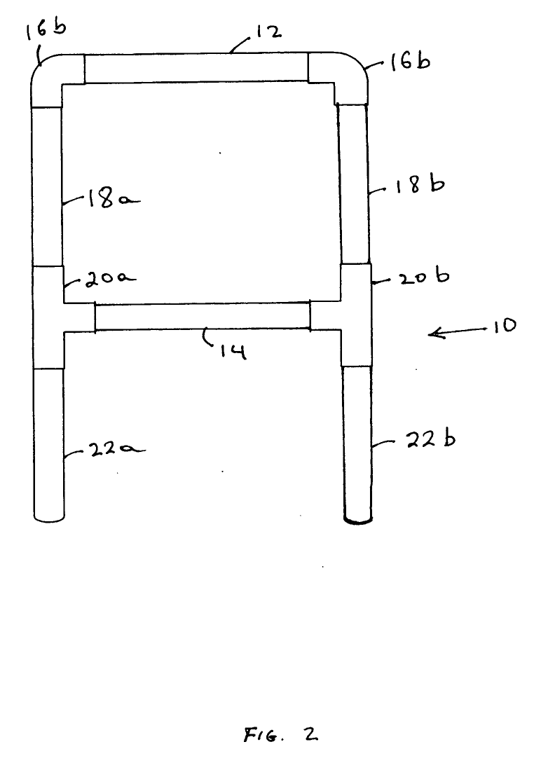

Referring now to FIG. 2, there is shown an assembled decorative display frame 10 wherein upper frame member 12 is connected to side frame members 18a and 18b via elbows 16a and 16b, respectively, lower frame member 14 is connected to side frame members 18a and 18b via tee connectors 20a and 20b, respectively, support 22a is connected to side frame member 18a and lower frame member 14 via tee connector 20a and support 22b is connected to side frame member 18b and lower frame member 14 via tee connector 20b.

In a typical application, decorative display frame 10 is supported in an upright position by supports 22a and 22b which are inserted securely in the ground of a yard or other outdoor surface. A picture, an announcement or other sign is attached to decorative display frame 10 for display. Other decorations such as ribbons, flowers or the like may be placed on decorative display frame 10 to enhance the visual pleasure and festivity of the display. More than one decorative display frames 10 with signs and decorations may be placed adjacent to each other to create a theme and message suitable for the particular occasion. Further, a banner containing a message such as “Happy Birthday,” Congratulations,” “It's a Boy” or the like may extend from one decorative display frame 10 to another decorative frame 10.

While a preferred embodiment of the invention has been shown and described, modifications thereof can be made by one skilled in the art without departing from the spirit of the invention.

What is claimed is:

1. A decorative display assembly, comprising:
a first tubular member;
a second tubular member; and
means for removably connecting the first tubular member to the second tubular member.

2. A decorative display assembly according to claim 1 further including:
a third tubular member; and
second means for removably connecting the third tubular member to the second tubular member.

3. A decorative display assembly according to claim 1 further including a sign attached to the first tubular member.

4. A decorative display assembly according to claim 1 further including a picture attached to the first tubular member.

5. A decorative display assembly according to claim 1 further including an announcement attached to the first tubular member.

6. A decorative display assembly according to claim 1 further including support means attached to the first tubular member for supporting the assembly.
